(19) United States
(12) Patent Application Publication
(10) Pub. No.: US 2008/0147953 A1
(43) Pub. Date: Jun. 19, 2008

(54) Automated processing device and equipment lockdown

(75) Inventor: George Lawandus, Encinitas, CA (US)

Correspondence Address: JAMES M. STOVER;TERADATA CORPORATION, 2835 MIAMI VILLAGE DRIVE, MIAMISBURG, OH, 45342, US

(73) Assignee: NCR Corporation

(21) Appl. No.: 11/642,087

(22) Filed: Dec. 19, 2006

(51) Int. Cl. G06F 13/20; H04Q 5/22

(52) U.S. Cl. 710/313; 340/10.42

(57) ABSTRACT

Various embodiments described herein provide systems, methods, and software to enable operation of one or more devices, workstations, equipment, controls, and other items only when an authorized operator or user is within a certain proximity of the item. Some of these embodiments include a peripheral device or control connection interface between the item to enable and disable the one or more items. Some embodiments further include one or more other item security elements. The one or more other item security elements may include one or more of a logon screen or device, a biometric feature reader, or other security elements.

### TECHNICAL FIELD

The inventive subject mater relates to securing controlled resources and, more particularly, to automated processing device and equipment lockdown.

### BACKGROUND INFORMATION

Protecting sensitive data and other intellectual property stored in and accessible from computers and other devices has been historically difficult. Various methods including physical isolation and biometric identification systems are currently employed to prevent unauthorized access to a particular computer workstation where password protected screen locks are not adequate for a particular security level. This is especially troublesome in secure high-density work environments where many people work in close proximity. Even though everyone in a particular environment might have the same level of security access, sensitive data is usually shared on a “need to know” basis. In these cases, individuals may be required to lock or even power off their workstations every time they leave the immediate area. Human nature dictates that we always tend to take the shortest path when it comes to repetitive tasks. For example, a workstation would not be locked down when left alone (for brief periods) in order to save the time it takes to unlock or power up the workstation. Enforcement of workstation security protocols can also be problematic in areas where large numbers of people work with secure data.

At the same time, preventing unauthorized use of device and other equipment can be equally difficult. For example, a control panel for a manufacturing process, a piece of heavy equipment, or a point-of-sale terminal, when not attended, may easily allow for easy manipulation by unauthorized or unqualified employees or others. Prior solutions to this issue have included keys, passwords, and the like. However, in similar situations as with computer workstations, when people leave their workstations, enforcement of lockdown procedures is difficult.

### BRIEF DESCRIPTION OF THE DRAWINGS

FIG. 1 is a schematic block diagram of a system according to an example embodiment.

FIG. 2 is an illustration of a piece of equipment according to an example embodiment.

FIG. 3 is a block diagram of a peripheral/control device interface according to an example embodiment.

FIG. 4 is a flow diagram of a method according to an example embodiment.

FIG. 5 is a flow diagram of a method according to an example embodiment.

### DETAILED DESCRIPTION

Various embodiments described herein provide systems, methods, and software to enable operation of one or more devices, workstations, equipment, controls, and other items only when an authorized operator or user is within a certain proximity of the item. Some of these embodiments include a peripheral device or control connection interface between the item to enable and disable the one or more items. Some embodiments further include one or more other item security elements. The one or more other item security elements may include one or more of a logon screen or device, a biometric feature reader, or other security elements.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein may be implemented in hardware, software or a combination of software and hardware in various embodiments. The software comprises computer executable instructions stored on computer readable medium such as memory or other type of storage devices. The term “computer readable medium” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in one, two, or more specific interconnected hardware modules or devices with related control and data signals communicated between and through the modules, or as portions of an application-specific integrated circuit. Thus, the exemplary process flow is applicable to software, firmware, and hardware implementations.

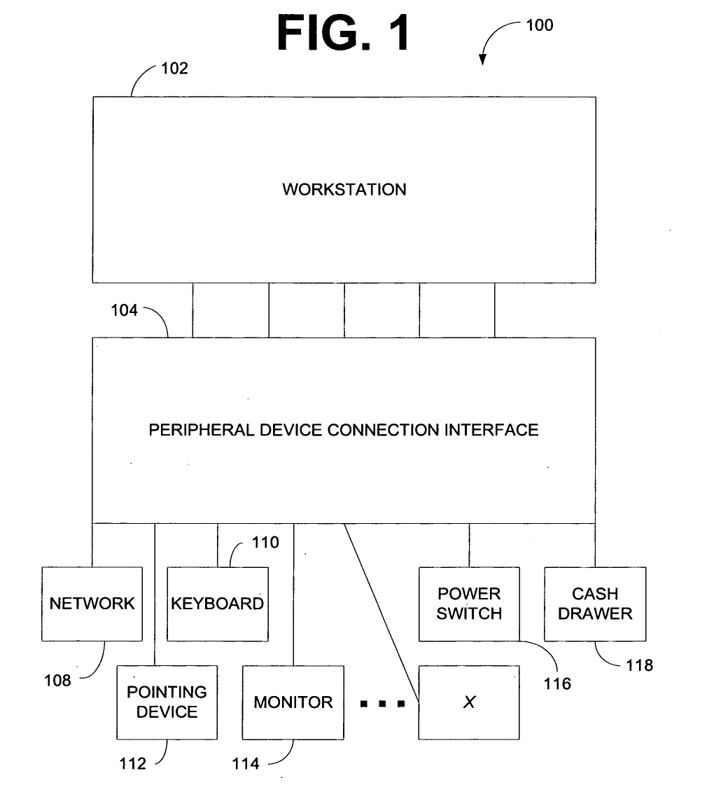

FIG. 1 is a schematic block diagram of a system 100 according to an example embodiment. The example system 100 includes a workstation 102 and a peripheral device connection interface 104. In some embodiments, the peripheral device connection interface 104 is internal to the workstation 102. In some such embodiments, the peripheral device connection interface may be embedded within a motherboard of the workstation 102, embedded on a board that is installed into a slot, such as a peripheral connection interface (“PCI”) slot of the motherboard within the workstation 102, or otherwise operatively coupled within a physical structure of the workstation 102. In other embodiments, the peripheral device connection interface 104 may be bolted to the workstation 102. In some such embodiments, the peripheral device connection interface 104 is bolted to the workstation 102 using security bolts that are well known in the relevant art to prevent removal of the peripheral device connection interface 104 from the workstation 104.

In some embodiments, the workstation 102 is a computer workstation. In other embodiments, the workstation 102 is a point-of-sale terminal, such as a cash register. In yet further embodiments, the workstation 102 is a control panel of a manufacturing line or industrial process, such as a control panel to control at least a portion of a petroleum refining processing plant or other chemical facility. The workstation 102 in other embodiments is a device or other item including controls and/or peripherals that provide control operations to the workstation 102 or another device or process.

The peripheral device connection interface 104 couples to one or more peripheral connections of the workstation 102 and couples to one or more controls or peripherals that do one or both of receive input for the workstation 102 and provide output from the workstation 102. In some embodiments, the controls or peripherals may include one or more of a network interface 108, a keyboard, a pointing device 112 such as a mouse, a monitor 114, a power switch 116, a cash drawer, and one of many other peripheral or control devices that can do one or both of receive input for and provide output from the workstation 102.

The peripheral device connection interface 104, in some embodiments, includes a switching mechanism that electrically switches the controls or peripherals to either enable or disable the respective controls or peripherals. In other embodiments, the switching mechanism intercepts interrupts and other signals from the one or more peripherals or other controls and prevents the interrupts or other signals from reaching their destination unless an authorized user has been authenticated. The controls or peripherals may be disabled when an authorized user leaves the workstation 102 unattended or fails to interact with the workstation for a certain period.

In some embodiments, the peripheral device connection interface 104 detects the presence of an authorized user using Radio Frequency Identification (“RFID”) technology.

A radio frequency identification (“RFID”) chip may be active or passive. An RFID chip may be, for example, embedded or mounted in a plastic carrier, such as a picture identification card issued to an employee. An RFID chip is, in one example embodiment, capable of emitting one or more signals that can be used by a reader component mounted in, on, or proximate the peripheral device connection interface. The reader component reads the RFID chip and obtains information stored in the chip that can be used to uniquely identify it. Accordingly, when an individual brings a RFID chip into proximity to a reader component, the reader component detects one or more signals from the RFID chip. The reader component in turn generates one or more signals or data that is indicative of the identity of the RFID chip. The peripheral device connection interface 104 may then compare the signal received from the RFID chip with a stored representation of authorized signals. If the comparing results in a match, the peripheral device connection interface 104 enables the peripherals and other controls. The reader component continues to detect the authorized RFID chip until the chip leaves a proximity of the reader component. When the RFID chip signal is no longer detected, the peripheral device connection interface switches the peripherals and other controls off, preventing interaction with the workstation 102.

In another embodiment, in order to operate the workstation, a user is issued a standard company badge with an embedded RFID chip. Once the user is in range of the peripheral device connection interface 104, a passive RFID chip reader will energize the RFID chip in the badge and cause the RFID chip to transmit a unique ID of the RFID chip. If the unique ID is recognized by the peripheral device connection interface 104, the attached peripherals are automatically unlocked and the workstation 102 becomes accessible. If the user moves out of the range of the device, the workstation 102 is automatically locked down.

In some embodiments, there may be more then one workstation 102 access-level. For example, the workstation 102 may have more than one user and each user's unique RFID chip ID enables certain peripherals or controls. At the same time, the unique RFID chip ID of a system administrator may allow the administrator access to the entire workstation 102. In some such embodiments the administrator may utilize this level of access in the event that a user misplaces their RFID chip. The administrator may access the workstation 102, deauthorize the misplaced RFID chip, and authorize a new RFID chip of the user.

Since it is possible, and even probable, that a badge will be lost, stolen, or borrowed, some embodiments are used in conjunction with biometric devices, such as a fingerprint reader to specifically authenticate the user in highly secured environments.

In some embodiments including a biometric device, the RFID chip reader energizes only after successfully matching a users thumbprint to an authorized thumbprint. Upon a successful match, the RFID chip reader energizes and receives a signal from a user's RFID chip embedded in the user's identification card. The peripheral device connection interface 104 matches the user's RFID chip ID to an authorized ID and enables the peripherals and other controls. In some such embodiments, the RFID chip reader remains energized until the authorized user's RFID chip is no longer within a proximity of the RFID chip reader. At that point, the RFID chip reader de-energizes and will only be re-energized upon successfully matching the user's thumbprint again.

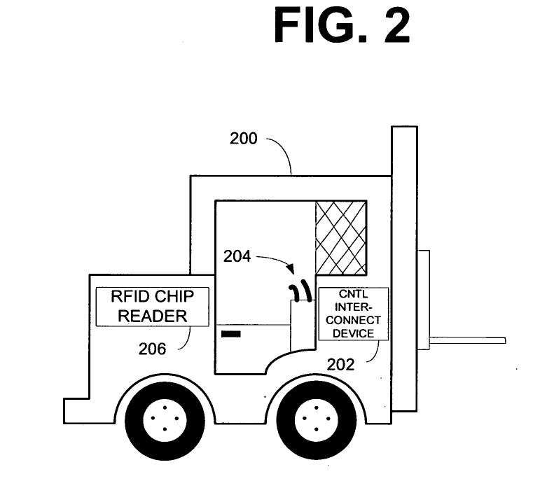

FIG. 2 is an illustration of a piece of equipment 200 according to an example embodiment. In the illustrated embodiments, the piece of equipment 200 is a forklift. However, other pieces of equipment and devices are contemplated.

The piece of equipment 200 includes controls 204 and a control device connection interface 202. The control device connection interface 202 is operatively installed between controls 204 of the piece of equipment 200 and the piece of equipment 200. Thus, input received by the controls 204 flows to the control device connection interface 202 before it reaches the piece of equipment 200.

In typical embodiments, a control device connection interface 202 prevents signals from the controls from reaching the piece of equipment 200 until an authorized operator comes into a certain proximity of the piece of equipment. The presence of an authorized operator is detected using an RFID chip reader embedded in or coupled to the control device connection interface 202. In such embodiments, authorized operators of the piece of equipment 200 are issued an RFID chip embedded within or attached to something, such as an identification card, a key, an item of clothing, or other item. When an authorized operator comes within range of the RFID chip reader, the controls 204 are enabled. When the authorized operator moves outside of the range of the RFID chip reader, the control 204 are disabled.

As discussed above with regards to workstations and other devices and controls, an employee identification cards and other items having embedded RFID chips can be lost, stolen, or borrowed. Thus, in some embodiments, other mechanisms my be used to verify that the holder of the item with the embedded RFID chip is in fact the person authorized to operate the piece of equipment 200. These other mechanisms may include a fingerprint reader, a keypad or keyboard for the operator to enter a personal identification number or password, or other device.

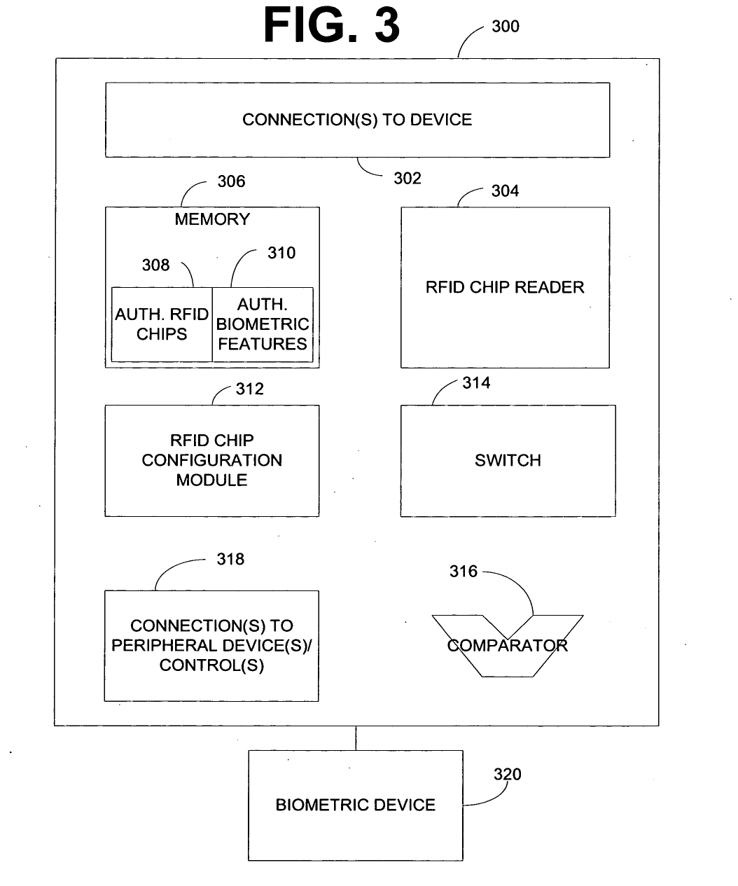

FIG. 3 is a block diagram of a peripheral/control device interface 300 according to an example embodiment. The example peripheral/control device interface 300 includes one or more device connection ports 302 to connect to one or more corresponding ports of a device. The peripheral/control device interface 300 further includes an RFID chip reader 304, a memory 306, and an RFID chip configuration module 312. The peripheral/control device interface 300 also includes a switch 314, a comparator 316, and one or more peripheral device/control connection ports 318 to connect to one or more peripheral devices and controls. Some embodiments further include a biometric device 320, such as a finger print reader.

In typical embodiments, the peripheral/control device interface 300 may be configured through the RFID chip configuration module 312. In some embodiments, the RFID chip configuration module 312 may be programmed using a processing device coupled to the device connection ports 302. In other embodiments, the RFID chip configuration module 312 include an additional port through which an administrator may connection to the RFID chip configuration module 312.

In some embodiments, configuring the peripheral/control device interface 300 includes using the RFID chip configuration module to store one or more authorized RFID chip codes 308 in a portion of the memory 308. In embodiments including biometric feature recognition, biometric feature data of authorized users or operators 310 is also stored in the memory 306.

The switch 314, in typical embodiments, is a mechanism that enables use of devices coupled to the peripheral/control device connection interface 300 when the RFID chip reader 304 detects the presence of an authorized RFID chip code. In such embodiments, the RFID chip reader 304 detects the presence of an RFID chip and receives the RFID chip's unique code. The peripheral/control device connection interface 300 then uses the comparator 316 to compare the received RFID chip code with the codes of authorized RFID chips 308 stored in the memory 306. If there is a match, the switch 314 enables signals from the one or more peripheral device/control connection ports 318 to the one or more device connections 302. The switch 314 then prevents signals from the peripheral device/control connection ports 318 to the one or more device connections 302 when the RFID chip reader 304 no longer detects the RFID chip of the authorized user.

Embodiments also including the biometric device 320 typically also require the user to scan a biometric feature, such as a finger print, using the biometric device 320. The comparator 316 then compares the scanned biometric feature data with biometric feature data of authorized users 310 stored in the memory 306. In such embodiments, both the biometric feature data and RFID chip code must match a code stored in the memory 306.

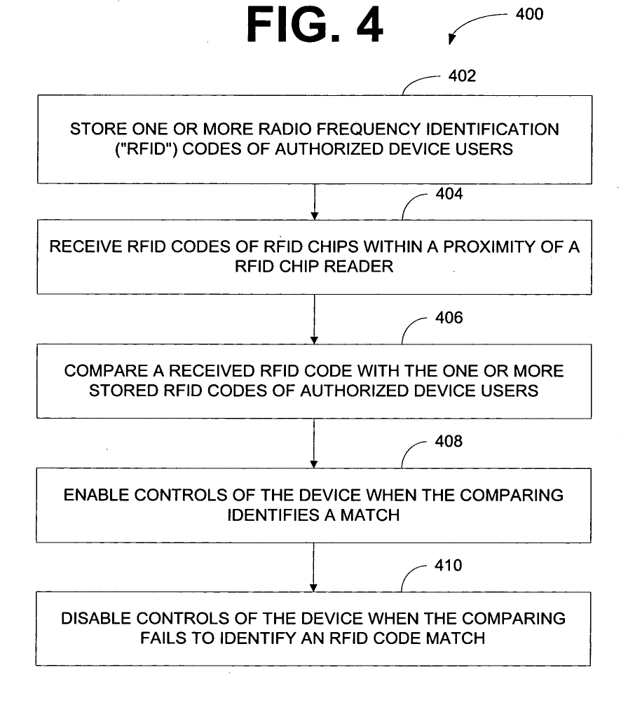

FIG. 4 is a flow diagram of a method 400 according to an example embodiment. The example method 400 includes storing one or more RFID codes of authorized device users 402, receiving RFID codes of RFID chips within a proximity of a RFID chip reader 404, and comparing a received RFID code with the one or more stored RFID codes of authorized device users 406. If the comparing 406 identifies a match, the method 400 includes enabling controls of the device 408. If the comparing 406 fails to identify a match, the method 400 includes disabling controls of the device 410. In some embodiments, disabling controls of the device when the comparing fails to identify a match includes disabling the controls when the RFID chip of an authorized user is no longer within the proximity of the RFID chip reader.

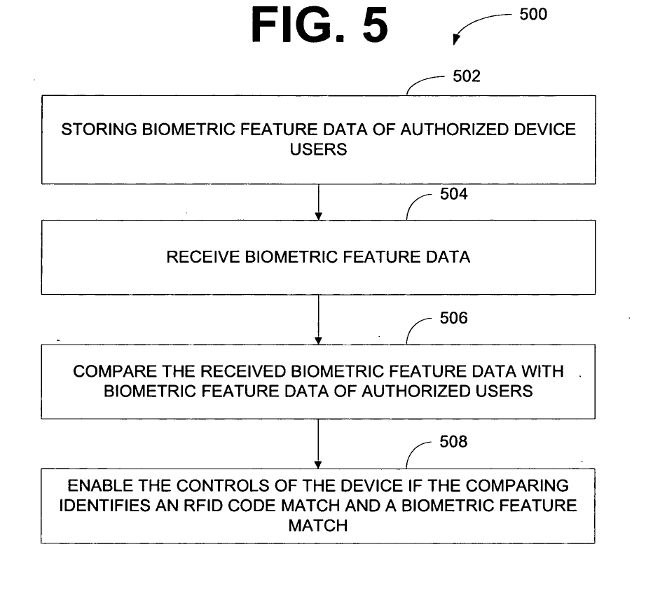

Some embodiments of the method 400 are extended further to include biometric feature comparing. An example of such an extension is illustrated in FIG. 5. FIG. 5 is a flow diagram of a 500 method according to an example embodiment. The method 500 further includes storing biometric feature data of authorized device users 502 and receiving biometric feature data 504. In such embodiments, the comparing 406 of the method 400 further includes comparing the received biometric feature data with biometric feature data of authorized users 506. Further, the enabling controls of the device 408 further includes enabling the controls of the device if the comparing identifies an RFID code match and a biometric feature match 508.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A peripheral device connection interface couplable to a processing device and one or more peripheral devices, the peripheral device connection interface including:
a Radio Frequency Identification (“RFID”) chip reader;
a RFID chip configuration module that stores codes of RFID chips authorized to use peripheral devices coupled to the peripheral device connection interface; and
a switching mechanism that enables use of peripheral devices coupled to the peripheral device connection interface when the RFID chip reader detects the presence of an authorized RFID chip code.

2. The peripheral device connection interface of claim 1, wherein the one or more peripheral devices include:
a keyboard;
a pointing device; and
a monitor.

3. The peripheral device connection interface of claim 2, wherein the one or more peripheral devices further include:
a network connection.

4. The peripheral device connection interface of claim 1, wherein the peripheral device connection interface includes:
one or more connection ports to connect to one or more peripheral connectors of the processing device; and
one or more peripheral connection ports to connect to the one or more peripheral devices.

5. The peripheral device connection interface of claim 1, wherein the peripheral device connection interface is within a housing of a processing device.

6. The peripheral device connection interface of claim 5, wherein the peripheral device connection interface is integrated portion of a processing device motherboard.

7. The peripheral device connection interface of claim 1, further comprising:
a biometric device;
a biometric feature data store to hold biometric feature data of authorized processing device users;
a biometric feature comparator to compare biometric feature data received from the biometric device with biometric feature data stored in the biometric feature data store; and
wherein the switching mechanism enables use of the peripheral devices coupled to the peripheral device connection interface when the RFID chip reader detects the presence of an authorized RFID chip code and the biometric feature comparator identifies a match between biometric feature data from the biometric device and the biometric feature data store.

8. The peripheral device connection interface of claim 7, wherein the biometric device includes a finger print reader.

9. A method comprising:
storing one or more Radio Frequency Identification (“RFID”) codes of authorized device users;
receiving RFID codes of RFID chips within a proximity of a RFID chip reader;
comparing a received RFID code with the one or more stored RFID codes of authorized device users;
enabling controls of the device when the comparing identifies a match; and
disabling controls of the device when the comparing fails to identify an RFID code match.

10. The method of claim 9, wherein disabling controls of the device when the comparing fails to identify a match includes disabling the controls when the RFID chip of an authorized user is no longer within the proximity of the RFID chip reader.

11. The method of claim 9, wherein the device is a computing device.

12. The method of claim 11, wherein the controls of the device include one or more computing device peripherals.

13. The method of claim 11, wherein the computing device is a point-of-sale terminal.

14. The method of claim 9, wherein the RFID chips are passive RFID chips.

15. The method of claim 9, further comprising:
storing biometric feature data of authorized device users;
receiving biometric feature data; and
wherein:
the comparing further includes comparing the received biometric feature data with biometric feature data of authorized users; and
the enabling controls of the device further includes enabling the controls of the device if the comparing identifies an RFID code match and a biometric feature match.

16. The method of claim 15, wherein the biometric feature data is biometric finger print data.

17. A method comprising:
detecting whether a Radio Frequency Identification (“RFID”) chip is within a proximity of a RFID chip reader; and
enabling or disabling one or more peripheral devices of a processing device as a function of the detecting.

18. The method of claim 17, wherein the one or more peripheral devices includes one or more input devices.

19. The method of claim 17, wherein disabling one or more peripheral devices includes disabling computer network traffic to and from the processing device.

20. The method of claim 17, wherein the processing device is a computer workstation.

21. The method of claim 17, wherein the processing device is a point-of-sale terminal.

22. A method comprising:
detecting whether a Radio Frequency Identification (“RFID”) chip is within a proximity of a RFID chip reader; and
enabling or disabling one or more controls of an item as a function of the detecting.

23. The method of claim 22, wherein the item is a forklift.

24. The method of claim 22, wherein the item is a control panel of at least a portion of equipment in a manufacturing environment.

25. The method of claim 22, wherein the one or more controls includes a throttle of the item.

26. The method of claim 22, wherein the RFID chip is embedded within an employee identification card.

27. A control connection interface couplable to an item and one or more item controls, the control connection interface including:
a Radio Frequency Identification (“RFID”) chip reader;
a RFID chip configuration module that holds codes of RFID chips authorized to operate the item;
a switching mechanism that enables use of the item controls coupled to the control connection interface when the RFID chip reader detects the presence of an authorized RFID chip code.

28. The control connection interface of claim 27, wherein the item is a piece of heavy equipment.

29. The control connection interface of claim 27, further comprising:
a biometric device;
a biometric feature data store to hold biometric feature data of authorized item users;
a biometric feature comparator to compare biometric feature data received from the biometric device with biometric feature data stored in the biometric feature data store; and
wherein the switching mechanism enables use of the one or more item controls coupled to the control connection interface when the RFID chip reader detects the presence of an authorized RFID chip code and the biometric feature comparator identifies a match between biometric feature data from the biometric device and the biometric feature data store.

30. The peripheral device connection interface of claim 29, wherein the biometric device includes a finger print reader.
